(19) United States
(12) Patent Application Publication
(10) Pub. No.: US 2022/0009789 A1
(43) Pub. Date: Jan. 13, 2022

(54) Precursor Solution Of Negative Electrode Active Material, Precursor Powder Of Negative Electrode Active Material, And Method For Producing Negative Electrode Active Material

(71) Applicant: Seiko Epson Corporation, Tokyo (JP)

(72) Inventors: Hitoshi YAMAMOTO, Chino (JP); Tsutomu TERAOKA, Matsumoto (JP)

(21) Appl. No.: 17/371,278

(22) Filed: Jul. 9, 2021

(30) Foreign Application Priority Data
Jul. 10, 2020 (JP) 2020-118979

(51) Int. Cl. C01G 23/00; H01M 10/0525

(52) U.S. Cl. CPC C01G 23/005; C01P 2004/62; C01P 2002/74; H01M 10/0525

(57) ABSTRACT

A precursor solution of a negative electrode active material according to the present disclosure contains at least one kind of organic solvent, a lithium compound that exhibits solubility in the organic solvent, and a titanium compound that exhibits solubility in the organic solvent. The lithium compound is preferably a lithium metal salt compound. The titanium compound is preferably a titanium alkoxide.

The present application is based on, and claims priority from JP Application Serial Number 2020-118979, filed Jul. 10, 2020, the disclosure of which is hereby incorporated by reference herein in its entirety.

### BACKGROUND

### 1. Technical Field

The present disclosure relates to a precursor solution of a negative electrode active material, a precursor powder of a negative electrode active material, and a method for producing a negative electrode active material.

### 2. Related Art

An all-solid-state battery has a configuration in which a carrier is conducted by a solid ion conductor, and is a battery having excellent heat resistance to a high temperature by adopting a non-flammable or flame-retardant solid electrolyte. Therefore, as compared with a battery using an electrolytic solution, there is no risk of liquid leakage, ignition associated with the liquid leakage, or the like. The battery is regarded promising as a battery having high safety.

Currently, in order to further improve energy density and output of the all-solid-state battery, an electrode material and a method for producing the electrode material are improved.

For example, a method is proposed in which a Li₃BO₃ powder and a TiO₂ powder are mixed at a mass ratio of 1:2 or more and 1:3 or less, the mixture is calcined at a temperature of 700° C. or higher and 800° C. or lower, and then the obtained negative electrode material calcined product is pulverized to obtain a negative electrode material powder (see JP-A-2016-103381).

When a sintered body of the negative electrode active material for use in the all-solid-state battery is to be produced, a filler as a sintering aid is used together with particles of the active material and the like. When the filler is filled among the particles of the active material or the like, the sintered body is densified. A sintered body having handleability to the extent that sintered particles do not fall off even in low-temperature calcination in which particle growth is prevented is obtained. Li₃BO₃ or the like having a relatively low melting point and lithium ion conductivity is widely used as the filler.

When lithium titanate represented by Li₄Ti₅O₁₂ is used as the negative electrode active material, a filler such as Li₃BO₃ reacts with Li₄Ti₅O₁₂ during calcination to generate a heterogeneous phase such as Li₂TiO₃. Such a heterogeneous phase has poor reaction activity and high resistance. Therefore, it is difficult to ensure density and charge and discharge performance at a high level.

### SUMMARY

The present disclosure is made to solve the above problems, and can be implemented as the following application examples.

A precursor solution of a negative electrode active material according to an application example of the present disclosure contains: at least one kind of organic solvent; a lithium compound that exhibits solubility in the organic solvent; and a titanium compound that exhibits solubility in the organic solvent.

A precursor powder of a negative electrode active material according to an application example of the present disclosure contains: an inorganic substance containing lithium and titanium, in which an average particle diameter is 400 nm or less.

A precursor powder of a negative electrode active material according to an application example of the present disclosure is obtained by subjecting the precursor solution of a negative electrode active material according to the present disclosure to a heat treatment.

A method for producing a negative electrode active material according to an application example of the present disclosure includes: an organic solvent removal step of heating the precursor solution of a negative electrode active material according to the present disclosure to remove the organic solvent; a molding step of molding a precursor powder of the negative electrode active material obtained in the organic solvent removal step to obtain a molded body; and a calcination step of calcinating the molded body.

### BRIEF DESCRIPTION OF THE DRAWINGS

FIG. 1 is a schematic perspective view schematically showing a configuration of a lithium ion secondary battery according to a first embodiment.

FIG. 2 is a schematic perspective view schematically showing a configuration of a lithium ion secondary battery according to a second embodiment.

FIG. 3 is a schematic cross-sectional view schematically showing a structure of the lithium ion secondary battery according to the second embodiment.

FIG. 4 is a schematic perspective view schematically showing a configuration of a lithium ion secondary battery according to a third embodiment.

FIG. 5 is a schematic cross-sectional view schematically showing a structure of the lithium ion secondary battery according to the third embodiment.

FIG. 6 is a schematic perspective view schematically showing a configuration of a lithium ion secondary battery according to a fourth embodiment.

FIG. 7 is a schematic cross-sectional view schematically showing a structure of the lithium ion secondary battery according to the fourth embodiment.

### DESCRIPTION OF EXEMPLARY EMBODIMENTS

Hereinafter, preferred embodiments according to the present disclosure will be described in detail.

### 1. Precursor Solution of Negative Electrode Active Material

First, a precursor solution of a negative electrode active material according to the present disclosure will be described.

The precursor solution of a negative electrode active material according to the present disclosure is a liquid composition used for forming the negative electrode active material described in detail later. In particular, the precursor solution of a negative electrode active material according to the present disclosure contains at least one kind of organic solvent, a lithium compound that exhibits solubility in the organic solvent, and a titanium compound that exhibits solubility in the organic solvent.

With such a configuration, it is possible to provide a precursor solution of a negative electrode active material that can form a negative electrode active material having a high denseness without requiring a treatment at a relatively high temperature and that can be suitably used in manufacture of a lithium ion secondary battery having excellent charge and discharge characteristics. More specifically, since the lithium compound and the titanium compound are contained in a dissolved state in the precursor solution, a precursor powder formed using the precursor solution can be made to contain lithium and titanium with microscopically high uniformity and have a small particle diameter, and the negative electrode active material finally obtained can be made to have a high denseness while an unintentional variation in composition at each site is suitably prevented. As a result, a complex oxide containing lithium and titanium can be suitably formed as a composite oxide having a desired composition while preventing formation of an unintended heterogeneous phase. The lithium ion secondary battery containing the negative electrode active material can be provided with excellent charge and discharge characteristics.

An average particle diameter of the precursor powder formed by using the precursor solution can be made extremely small as will be described later in detail. Accordingly, a calcination temperature of the precursor powder at the time of forming the negative electrode active material can be suitably lowered by a so-called Gibs-Thomson effect, which is a melting point lowering phenomenon due to an increase in surface energy. That is, the negative electrode active material and the lithium ion secondary battery can be formed by a calcination treatment at a relatively low temperature.

On the other hand, when conditions described above are not satisfied, a satisfactory result is not obtained.

For example, when at least one of the lithium compound and the titanium compound contained in the precursor solution does not exhibit the solubility in the organic solvent contained in the precursor solution, it is difficult to contain the precursor powder formed using the precursor solution in a state where lithium and titanium are microscopically and sufficiently uniform. As a result, it is not possible to sufficiently prevent the unintentional variation in the composition in each site of the finally obtained negative electrode active material, and it is not possible to sufficiently increase the denseness of the negative electrode active material. It is not possible to sufficiently prevent formation of an unintended heterogeneous phase, and it is not possible to obtain sufficiently excellent charge and discharge characteristics of a lithium ion secondary battery containing the negative electrode active material.

### 1-1. Organic Solvent

The precursor solution according to the present disclosure contains at least one kind of organic solvent.

The organic solvent has a function of dissolving the lithium compound and the titanium compound.

Examples of the organic solvent include alcohols, glycols, ketones, esters, ethers, organic acids, aromatics, amides, and aliphatic hydrocarbons. A mixed solvent which is one type or a combination of two or more types selected from these can be used. Examples of the alcohols include methyl alcohol, ethyl alcohol, n-propyl alcohol, isopropyl alcohol, n-butyl alcohol, allyl alcohol, and ethylene glycol monobutyl ether. Examples of the glycols include ethylene glycol, propylene glycol, butylene glycol, hexylene glycol, pentanediol, hexanediol, heptanediol, and dipropylene glycol. Examples of the ketones include dimethyl ketone, methyl ethyl ketone, methyl propyl ketone, and methyl isobutyl ketone. Examples of the esters include methyl formate, ethyl formate, methyl acetate, and methyl acetoacetate. Examples of ethers include ethylene glycol monobutyl ether, diethylene glycol monomethyl ether, diethylene glycol monoethyl ether, diethylene glycol dimethyl ether, ethylene glycol monomethyl ether, ethylene glycol monoethyl ether, and dipropylene glycol monomethyl ether. Examples of the organic acids include formic acid, acetic acid, 2-ethyl-butyric acid, and propionic acid. Examples of the aromatics include toluene, ortho-xylene, and paraxylene. Examples of the amides include formamide, N,N-dimethylformamide, N,N-diethylformamide, dimethylacetamide, and N-methylpyrrolidone. Examples of the aliphatic hydrocarbons include hexane, heptane, and octane.

Among these, the organic solvent is preferably a non-aqueous solvent containing one or more selected from the group consisting of n-butyl alcohol, ethylene glycol monobutyl ether, butylene glycol, hexylene glycol, pentanediol, hexanediol, heptanediol, toluene, orthoxylene, paraxylene, hexane, heptane, and octane.

Accordingly, the solubility of the lithium compound and the titanium compound in the organic solvent can be made excellent, the organic solvent can be efficiently removed while bumping of the organic solvent in an organic solvent removal step described later is prevented, and the productivity of the precursor powder and the negative electrode active material can be made more excellent. A content of an organic substance in the negative electrode active material produced using the precursor solution can be more suitably and sufficiently low.

A mass ratio of n-butyl alcohol, ethylene glycol monobutyl ether, butylene glycol, hexylene glycol, pentanediol, hexanediol, heptanediol, toluene, orthoxylene, paraxylene, hexane, heptane, and octane in the organic solvent constituting the precursor solution is preferably 50% by mass or more, more preferably 90% by mass or more, and still more preferably 99% by mass or more.

Accordingly, the above effects are more remarkably exhibited.

The content of the organic solvent in the precursor solution is preferably 78.0% by mass or more and 97.0% by mass or less, more preferably 85.0% by mass or more and 95.5% by mass or less, and still more preferably 89.0% by mass or more and 94.0% by mass or less.

Accordingly, the dissolved state of the lithium compound and the titanium compound in the precursor solution can be made more suitable, and the above effects are more remarkably exhibited. In addition, ease of handling of the precursor solution and the productivity of the precursor powder and the negative electrode active material can be made more excellent.

### 1-2. Lithium Compound

The precursor solution according to the present disclosure contains at least one kind of lithium compound.

The lithium compound functions as a lithium source of a composite oxide constituting the negative electrode active material.

At least a part of the lithium compound is contained in the precursor solution in a state of being dissolved in the organic solvent.

The mass ratio of the lithium compound contained in the precursor solution in the state of being dissolved in the organic solvent is preferably 90% by mass or more, more preferably 95% by mass or more, and still more preferably 99% by mass or more, among all lithium compounds contained in the precursor solution.

Accordingly, the above effects are more reliably exhibited.

When the precursor solution contains a lithium compound that is not dissolved in the organic solvent, a size of the lithium compound that is not dissolved in the organic solvent is preferably 1.0 μm or less, more preferably 0.5 μm or less, and still more preferably 0.3 μm or less in terms of the particle diameter.

Accordingly, dispersibility of the lithium compound that is not dissolved in the organic solvent in the precursor solution can be made excellent, and occurrence of a microscopic concentration unevenness of the lithium compound in the precursor solution can be sufficiently prevented. In particular, such an effect is more remarkably exhibited when the ratio of the lithium compound contained in the precursor solution in the state of being dissolved in the organic solvent is sufficiently large as described above, among all the lithium compounds contained in the precursor solution.

The lithium compound is not particularly limited as long as it exhibits the solubility in the organic solvent constituting the precursor solution. Examples of the lithium compound include inorganic salts such as LiH, LiF, LiCl, LiBr, LiI, LiClO, LiClO₄, LiNO₃, LiNO₂, Li₃N, LiN₃, LiNH₂, Li₂SO₄, Li₂S, LiOH, and Li₂CO₃, carboxylates such as lithium formate, lithium acetate, lithium propionate, lithium 2-ethylhexanoate, and lithium stearate, hydroxy acid salts such as lithium lactate, lithium malate, and lithium citrate, dicarboxylate salts such as lithium oxalate, lithium malonate, and lithium maleate, alkoxides such as methoxylithium, ethoxylithium, and isopropoxylithium, alkylated lithium such as methyllithium and n-butyllithium, sulfate esters such as n-butyl lithium sulfate, n-hexyl lithium sulfate, and lithium dodecyl sulfate, and diketone complexes such as 2,4-pentanedionatolithium. Lithium metal salt compounds are preferred.

Accordingly, the dissolved state of the lithium compound in the precursor solution can be made more suitable, and the above effects are more remarkably exhibited.

Among the lithium metal salt compounds, the lithium compound is preferably an oxoacid salt.

Accordingly, a melting point of a calcined body formed using the precursor solution, for example, the precursor powder according to the present disclosure described later, can be suitably lowered. As a result, by the calcination treatment which is a heat treatment at a relatively low temperature for a relatively short time, it is possible to suitably convert the the precursor solution into the negative electrode active material while promoting crystal growth. In addition, an intensity of a negative electrode formed of a material containing the negative electrode active material, the reliability of a battery including the negative electrode, and the charge and discharge characteristics can be made more excellent.

An oxo anion constituting the oxoacid salt preferably contains no metal element. Examples of the oxo anion include a halogen oxoate ion, a borate ion, a carbonate ion, an orthocarbonate ion, a carboxylate ion, a silicate ion, a nitrite ion, a nitrate ion, a phosphite ion, a phosphate ion, an arsenate ion, a sulfite ion, a sulfate ion, a sulfonate ion, and a sulfinate ion. Examples of the halogen oxoate ion include a hypochlorite ion, a chlorite ion, a chlorate ion, a perchlorate ion, a hypobromite ion, a bromite ion, a bromate ion, a perbromate ion, a hypoiodite ion, an iodite ion, an iodate ion, and a periodate ion.

In particular, among oxoacid salts which are lithium metal salt compounds, the lithium compound is more preferably a nitrate, that is, LiNO₃.

Accordingly, the above effects are more remarkably exhibited.

The content of the lithium compound in the precursor solution is preferably 0.6% by mass or more and 4.7% by mass or less, more preferably 0.9% by mass or more and 3.2% by mass or less, and still more preferably 1.2% by mass or more and 2.6% by mass or less.

Accordingly, the dissolved state of the lithium compound in the precursor solution can be made more suitable, and the above effects are more remarkably exhibited. In addition, the ease of handling of the precursor solution and the productivity of the precursor powder and the negative electrode active material can be made more excellent. When a ratio between the titanium content and the lithium content in the precursor solution when a stoichiometric composition of the following composition formula (1) is satisfied is used as a reference, in other words, when a ratio between the lithium content and the titanium content in the precursor solution is 4:5 in molar ratio, the titanium compound and the lithium compound are preferably contained such that the lithium content is 1.00 times or more and 1.20 times or less with respect to the reference. That is, the molar ratio between the lithium content and the titanium content in the precursor solution is preferably 4.00:5.00 to 4.80:5.00.

Li₄Ti₅O₁₂ (1)

Accordingly, the negative electrode active material formed using the precursor solution can be made to be mainly formed of Li₄Ti₅O₁₂ and have a lower content of undesirable impurities. As a result, the charge and discharge characteristics of the battery including the negative electrode containing the negative electrode active material can be made more excellent.

The lithium content in the precursor solution with respect to the reference is preferably 1.00 time or more and 1.20 times or less, more preferably 1.00 time or more and 1.18 times or less, and still more preferably 1.00 time or more and 1.15 times or less.

Accordingly, the above effects are more remarkably exhibited.

### 1-3. Titanium Compound

The precursor solution according to the present disclosure contains at least one kind of titanium compound.

The titanium compound functions as a titanium source of the composite oxide constituting the negative electrode active material.

At least a part of the titanium compound is contained in the precursor solution in a state of being dissolved in the organic solvent.

The mass ratio of the titanium compound contained in the precursor solution in the state of being dissolved in the organic solvent is preferably 90% by mass or more, more preferably 95% by mass or more, and still more preferably 99% by mass or more, among all titanium compounds contained in the precursor solution.

Accordingly, the above effects are more reliably exhibited.

When the precursor solution contains a titanium compound that is not dissolved in the organic solvent, a size of the titanium compound that is not dissolved in the organic solvent is preferably 1.0 μm or less, more preferably 0.5 μm or less, and still more preferably 0.3 μm or less in terms of the particle diameter.

Accordingly, dispersibility of the titanium compound that is not dissolved in the organic solvent in the precursor solution can be made excellent, and occurrence of a microscopic concentration unevenness of the titanium compound in the precursor solution can be sufficiently prevented. In particular, such an effect is more remarkably exhibited when the mass ratio of the titanium compound contained in the precursor solution in the state of being dissolved in the organic solvent is sufficiently large as described above, among all the titanium compounds contained in the precursor solution.

The titanium compound is not particularly limited as long as it exhibits the solubility in the organic solvent constituting the precursor solution. Examples of the titanium compound include titanium metal salts such as titanium chloride, titanium nitrate, titanium sulfate and titanium acetate, a titanium alkoxide, and a titanium hydroxide. The titanium alkoxide is preferred.

Accordingly, the dissolved state of the titanium compound in the precursor solution can be made more suitable, and the above effects are more remarkably exhibited.

Examples of the titanium alkoxide include titanium methoxide, titanium ethoxide, titanium propoxide, titanium isopropoxide, titanium normal butoxide, titanium isobutoxide, titanium secondary butoxide, titanium tertiary butoxide, and poly(dibutyl titanate). Poly(dibutyl titanate) and titanium (IV) isopropoxide are preferred.

Accordingly, the above effects are more remarkably exhibited.

The content of the titanium compound in the precursor solution is preferably 2.4% by mass or more and 17.3% by mass or less, more preferably 3.6% by mass or more and 11.8% by mass or less, and still more preferably 4.8% by mass or more and 8.4% by mass or less.

Accordingly, the dissolved state of the titanium compound in the precursor solution can be made more suitable, and the above effects are more remarkably exhibited. In addition, ease of handling of the precursor solution and the productivity of the precursor powder and the negative electrode active material can be made more excellent.

### 1-4. Other Components

The precursor solution according to the present disclosure contains an organic solvent, a lithium compound, and a titanium compound, and may further contain other components.

Examples of such components include polyvinylidene fluoride and polytetrafluoroethylene.

The content of the components other than the organic solvent, the lithium compound, and the titanium compound in the precursor solution is preferably 10% by mass or less, more preferably 5.0% by mass or less, and still more preferably 3.0% by mass or less.

A water content in the precursor solution is preferably 300 ppm or less, more preferably 200 ppm or less, and still more preferably 100 ppm or less.

Accordingly, the charge and discharge characteristics of the battery including the negative electrode containing the negative electrode active material formed using the precursor solution can be made more excellent.

### 2. Precursor Powder of Negative Electrode Active Material

Next, a precursor powder of a negative electrode active material according to the present disclosure will be described.

The precursor powder of the negative electrode active material according to the present disclosure is obtained by subjecting the above precursor solution according to the present disclosure to a heat treatment.

Accordingly, it is possible to provide a precursor powder of a negative electrode active material that can form a negative electrode active material having a high denseness without requiring a treatment at a relatively high temperature and that can be suitably used in manufacture of a lithium ion secondary battery having excellent charge and discharge characteristics.

The precursor powder of the negative electrode active material according to the present disclosure is formed of an inorganic substance containing lithium and titanium, and has an average particle diameter of 400 nm or less.

Accordingly, it is possible to provide a precursor powder of a negative electrode active material that can form a negative electrode active material having a high denseness without requiring a treatment at a relatively high temperature and that can be suitably used in manufacture of a lithium ion secondary battery having excellent charge and discharge characteristics. More specifically, a calcination temperature of the precursor powder at the time of forming the negative electrode active material can be suitably lowered by a so-called Gibs-Thomson effect, which is a melting point lowering phenomenon due to an increase in surface energy. That is, the negative electrode active material and the lithium ion secondary battery can be formed by a calcination treatment at a relatively low temperature. A powder having such an extremely small particle diameter cannot be obtained with the negative electrode active material obtained by a solid phase method in the related art.

In the present description, the average particle diameter refers to a median diameter D50, and can be determined, for example, by performing measurement using a particle diameter distribution analysis device, for example, MicroTrack MT3300EXII manufactured by Nikkiso Co., Ltd., in a state where a sample is dispersed in water.

The average particle diameter of the precursor powder is preferably 400 nm or less, more preferably 100 nm or more and 360 nm or less, and still more preferably 200 nm or more and 330 nm or less.

Accordingly, the above effects are more remarkably exhibited.

The precursor powder preferably contains an oxoacid compound.

Accordingly, the melting point of the precursor powder can be suitably lowered. As a result, by the calcination treatment which is a heat treatment at a relatively low temperature for a relatively short time, it is possible to suitably convert the precursor powder into the negative electrode active material while promoting crystal growth. In addition, an intensity of a negative electrode formed of a material containing the negative electrode active material, reliability of a battery including the negative electrode, and the charge and discharge characteristics can be made more excellent.

The precursor powder containing the oxoacid compound can be suitably produced by using the oxoacid salt as the lithium compound or the titanium compound which is a constituent component of the above precursor solution, particularly by using the oxoacid salt as the lithium compound which is the constituent component of the precursor solution.

The oxo anion constituting the oxoacid compound preferably contains no metal element. Examples of the oxo anion include a halogen oxoate ion, a borate ion, a carbonate ion, an orthocarbonate ion, a carboxylate ion, a silicate ion, a nitrite ion, a nitrate ion, a phosphite ion, a phosphate ion, an arsenate ion, a sulfite ion, a sulfate ion, a sulfonate ion, and a sulfinate ion. Examples of the halogen oxoate ion include a hypochlorite ion, a chlorite ion, a chlorate ion, a perchlorate ion, a hypobromite ion, a bromite ion, a bromate ion, a perbromate ion, a hypoiodite ion, an iodite ion, an iodate ion, and a periodate ion.

When the oxoacid salt is used as the lithium compound or the titanium compound which is the constituent component of the above precursor solution, the oxo anion constituting the oxoacid compound contained in the precursor powder is usually the same type as the oxo anion constituting the oxoacid salt which is the constituent component of the precursor solution.

When a ratio between the titanium content and the lithium content in the precursor powder when a stoichiometric composition of the following composition formula (1) is satisfied is used as a reference, in other words, when a ratio between the lithium content and the titanium content in the precursor powder is 4:5 in molar ratio, the titanium compound and the lithium compound are preferably contained such that the lithium content is 1.00 times or more and 1.20 times or less with respect to the reference. That is, the molar ratio between the lithium content and the titanium content in the precursor powder is preferably 4.00:5.00 to 4.80:5.00.

Li₄Ti₅O₁₂ (1)

Accordingly, the negative electrode active material formed using the precursor powder can be made to be mainly formed of Li₄Ti₅O₁₂ and have a lower content of undesirable impurities. As a result, the charge and discharge characteristics of the battery including the negative electrode containing the negative electrode active material can be made more excellent.

The lithium content in the precursor powder with respect to the reference is preferably 1.00 time or more and 1.20 times or less, more preferably 1.00 time or more and 1.18 times or less, and still more preferably 1.00 time or more and 1.15 times or less.

Accordingly, the above effects are more remarkably exhibited.

The precursor powder is formed of an inorganic substance containing lithium and titanium, and may contain a small amount of an organic substance. Examples of such an organic substance include those derived from an organic compound such as the organic solvent contained in the above precursor solution. When an organometallic compound is used as at least one of the lithium compound and the titanium compound, an organic substance derived from the organometallic compound may be contained.

The content of the organic substance contained in the precursor powder is preferably 200 ppm or less, more preferably 150 ppm or less, and still more preferably 100 ppm or less.

The precursor powder according to the present disclosure can be suitably produced, for example, by subjecting the precursor solution according to the present disclosure described above to the heat treatment. More specifically, the precursor powder according to the present disclosure can be suitably produced by a method of performing the organic solvent removal step described in detail later. The precursor powder according to the present disclosure can be more suitably produced by performing an organic substance removal step described in detail later after the organic solvent removal step.

### 3. Method for Producing Negative Electrode Active Material

Next, a method for producing the negative electrode active material according to the present disclosure will be described.

The method for producing the negative electrode active material according to the present disclosure includes the organic solvent removal step of heating the precursor solution according to the present disclosure to remove the organic solvent, a molding step of molding the precursor powder obtained in the organic solvent removal step to obtain a molded body, and a calcination step of calcinating the molded body.

Accordingly, it is possible to provide the method for producing the negative electrode active material that can form the negative electrode active material having a high denseness without requiring a treatment at a relatively high temperature and that can be suitably used in manufacture of a lithium ion secondary battery having excellent charge and discharge characteristics.

### 3-1. Organic Solvent Removal Step

In the organic solvent removal step, the precursor solution according to the present disclosure is heated to remove the organic solvent.

A heating temperature in this step varies depending on a composition of the organic solvent and the like. When a boiling point of the organic solvent is defined as Tbp [° C], the heating temperature is preferably (Tbp−40)° C. or higher and (Tbp+40)° C. or lower, more preferably (Tbp−30)° C. or higher and (Tbp+30)° C. or lower, and still more preferably (Tbp−20)° C. or higher and (Tbp+20)° C. or lower.

Accordingly, the productivity of the negative electrode active material can be made more excellent while the content of undesirable impurities such as the organic substance in the finally obtained negative electrode active material is made sufficiently low.

This step may be performed, for example, in an inert gas atmosphere such as air, a hydrogen gas atmosphere, a nitrogen gas atmosphere, or an argon gas atmosphere, or may be performed in a reduced-pressure environment.

When this step is performed under the reduced-pressure environment, this step can be performed, for example, in an environment having a degree of vacuum of 10 Pa to 100 Pa.

This step may be performed, for example, in a state where humidity of the atmosphere is reduced, in other words, in a state where a degree of drying is increased.

A treatment time in this step is not particularly limited, and is preferably 20 minutes or longer and 240 minutes or shorter, more preferably 30 minutes or longer and 180 minutes or shorter, and still more preferably 50 minutes or longer and 120 minutes or shorter.

Accordingly, the productivity of the negative electrode active material can be made more excellent while the content of undesirable impurities such as the organic substance in the finally obtained negative electrode active material is made sufficiently low.

This step may be performed in a state where the precursor solution is allowed to stand, or may be performed while stirring the precursor solution.

In this step, a treatment having two or more stages under different conditions may be performed. For example, at least one of the treatment temperature, the composition of the atmosphere, the pressure, and a stirring condition may be changed during this step.

At the end of this step, the content of the organic solvent in the obtained composition is preferably 3.0% by mass or less, more preferably 1.0% by mass or less, and still more preferably 0.5% by mass or less.

### 3-2. Organic Substance Removal Step

In the present embodiment, an organic substance removal step of removing the organic substance contained in the composition obtained by removing the organic solvent from the precursor solution is further included between the above organic solvent removal step and the molding step described below.

Accordingly, the content of the organic substance, which is an impurity, in the finally obtained negative electrode active material can be made sufficiently low, and the reliability of the negative electrode active material and the battery containing the negative electrode active material can be made more excellent. In addition, a calcined body which is a precursor of the negative electrode active material can be obtained. A treatment condition of a subsequent calcination step can be relaxed. The productivity and the reliability of the negative electrode active material can be made more excellent.

The heating temperature in the step is preferably 280° C. or higher and 650° C. or lower, more preferably 300° C. or higher and 600° C. or lower, and still more preferably 330° C. or higher and 580° C. or lower.

Accordingly, the content of the organic substance, which is an impurity, in the finally obtained negative electrode active material can be made lower, and the reliability of the negative electrode active material and the battery containing the negative electrode active material can be made more excellent. It is possible to more efficiently obtain the calcined body which is the precursor of the negative electrode active material while preventing excessive progress of calcination of the composition. It is possible to further improve the productivity and the reliability of the negative electrode active material.

When the heating temperature in the organic solvent removal step is T1 [° C.] and the heating temperature in the organic substance removal step is T2 [° C], a relationship of 200≤T2−T1≤500 is preferably satisfied, a relationship of 250≤T2−T1≤450 is more preferably satisfied, and a relationship of 300≤T2−T1≤400 is still more preferably satisfied.

Accordingly, the content of the organic substance, which is an impurity, in the finally obtained negative electrode active material can be made lower, and the reliability of the negative electrode active material and the battery containing the negative electrode active material can be made more excellent. It is possible to more efficiently obtain the calcined body which is the precursor of the negative electrode active material while preventing excessive progress of calcination of the composition. It is possible to further improve the productivity and the reliability of the negative electrode active material.

When at least one of the heating temperature in the organic solvent removal step and the heating temperature in the organic substance removal step varies, a maximum heating temperature in each step is adopted as T1 and T2.

This step may be performed, for example, in an inert gas atmosphere such as air, a hydrogen gas atmosphere, a nitrogen gas atmosphere, or an argon gas atmosphere, or may be performed in a reduced-pressure environment.

When this step is performed under the reduced-pressure environment, this step can be performed, for example, in an environment having a degree of vacuum of 10 Pa to 100 Pa.

This step may be performed, for example, in a state where humidity of the atmosphere is reduced, in other words, in a state where a degree of drying is increased.

The treatment time in this step is not particularly limited, and is preferably 20 minutes or longer and 240 minutes or shorter, more preferably 30 minutes or longer and 180 minutes or shorter, and still more preferably 50 minutes or longer and 120 minutes or shorter.

Accordingly, the content of the organic substance, which is an impurity, in the finally obtained negative electrode active material can be made lower, and the reliability of the negative electrode active material and the battery containing the negative electrode active material can be made more excellent. It is possible to more efficiently obtain the calcined body which is the precursor of the negative electrode active material while preventing excessive progress of calcination of the composition. It is possible to further improve the productivity and the reliability of the negative electrode active material.

This step may be performed in a state where the composition obtained in the organic solvent removal step is allowed to stand, or may be performed while stirring the composition obtained in the organic solvent removal step.

In this step, a treatment having two or more stages under different conditions may be performed. For example, at least one of the treatment temperature, the composition of the atmosphere, the pressure, and a stirring condition may be changed during the step.

The content of the organic substance at the end of this step is preferably 500 ppm or less, more preferably 300 ppm or less, and still more preferably 100 ppm or less.

### 3-3. Pulverization Step

In the present embodiment, a pulverization step of pulverizing the calcined body obtained in the organic substance removal step is further provided between the organic substance removal step described above and the molding step described later.

Accordingly, molding in the molding step can be more suitably performed, dimensional accuracy and the denseness of the finally obtained negative electrode active material can be made more excellent, and the reliability of the negative electrode active material and the battery containing the negative electrode active material can be made more excellent. In addition, the productivity of the negative electrode active material and the battery can be made more excellent. In the following description, a case where the precursor powder according to the present disclosure described above is obtained by the pulverization step will be representatively described.

This step can be suitably performed, for example, by pulverization using a mortar.

The average particle diameter of the powder obtained in this step is preferably 400 nm or less, more preferably 100 nm or more and 360 nm or less, and still more preferably 200 nm or more and 330 nm or less.

Accordingly, the above effects are more remarkably exhibited.

### 3-4. Molding Step

In the molding step, the precursor powder obtained in the above step is molded to obtain a molded body.

This step can be performed by, for example, press molding.

A load during the press molding is preferably 300 MPa or more and 1000 MPa or less, more preferably 400 MPa or more and 900 MPa or less, and still more preferably 500 MPa or more and 800 MPa or less.

This step may be performed, for example, while heating the precursor powder.

In this case, the heating temperature in the step may be 50° C. or higher and 400° C. or lower.

In this step, the molding may be performed in combination with a component other than the precursor powder.

Examples of such a component include a crystalline powder-like negative electrode active material such as Li₄Ti₅O₁₂, a solid electrolyte and a precursor thereof, and a negative electrode active material and a precursor thereof. Such a component may be used, for example, in a step before the molding step. More specifically, for example, in the organic solvent removal step, the above component may be used together with the precursor solution, or in the organic substance removal step, the above component may be used together with the composition obtained by removing the organic solvent.

### 3-5. Calcination Step

In the calcination step, the molded body obtained in the above step is calcined.

Accordingly, a negative electrode active material having a shape corresponding to the molded body is obtained.

The heating temperature in this step is preferably 700° C. or higher and 1200° C. or lower, more preferably 750° C. or higher and 1100° C. or lower, and still more preferably 800° C. or higher and 1000° C. or lower.

Accordingly, the denseness of the produced negative electrode active material can be made higher while preventing the energy amount required for calcination, and the charge and discharge characteristics of the battery containing the negative electrode active material can be made more excellent. This is also advantageous in increasing the productivity of the negative electrode active material.

This step may be performed, for example, in an inert gas atmosphere such as air, a hydrogen gas atmosphere, a nitrogen gas atmosphere, or an argon gas atmosphere, or may be performed in a reduced-pressure environment.

When this step is performed under the reduced-pressure environment, this step can be performed, for example, in an environment having a degree of vacuum of 10 Pa to 100 Pa.

The treatment time in the step is not particularly limited, and is preferably 1 hour or longer and 24 hours or shorter, more preferably 2 hours or longer and 18 hours or shorter, and still more preferably 4 hours or longer and 12 hours or shorter.

Accordingly, the denseness of the produced negative electrode active material can be made higher while preventing the energy amount required for calcination, and the charge and discharge characteristics of the battery containing the negative electrode active material can be made more excellent. This is also advantageous in increasing the productivity of the negative electrode active material.

In this step, a treatment having two or more stages under different conditions may be performed. For example, at least one of the treatment temperature, the composition of the atmosphere, and the pressure may be changed during the step.

The denseness of the negative electrode active material obtained as described above is preferably 60% or more, more preferably 85% or more, and still more preferably 90% or more and 100% or less.

When the denseness of the negative electrode active material is sufficiently high as described above, a mass ratio of voids in the negative electrode active material is sufficiently small, and the charge and discharge characteristics of the battery containing the negative electrode active material can be made more excellent.

In the present description, the denseness refers to a ratio of a bulk density to a specific gravity 3.418 of Li₄Ti₅O₁₂ when the bulk density of the negative electrode active material is obtained based on an accurate volume and an accurate mass, taht is, measurement values obtained by performing dimension measurement on the negative electrode active material having a predetermined size and shape. When the negative electrode active material has a disc shape, for example, a digimatic caliper CD-15APX manufactured by Mitutoyo Corporation can be used for the measurement of the diameter, and for example, a mumate which is a digital micrometer manufactured by Sony Corporation can be used for the measurement of the thickness.

### 4. Battery

Next, a battery to which the present disclosure is applied will be described.

In the following description, a lithium ion secondary battery, which is an all-solid-state battery, will be representatively described as an example of the battery.

The battery according to the present disclosure contains the negative electrode active material formed by using the precursor solution and the precursor powder according to the present disclosure described above, and can be produced by, for example, applying the method for producing the negative electrode active material according to the present disclosure described above.

Such a battery contains a negative electrode active material having a high denseness, and is excellent in the charge and discharge characteristics.

### 4-1. Lithium Ion Secondary Battery According to First Embodiment

Hereinafter, a lithium ion secondary battery according to a first embodiment will be described.

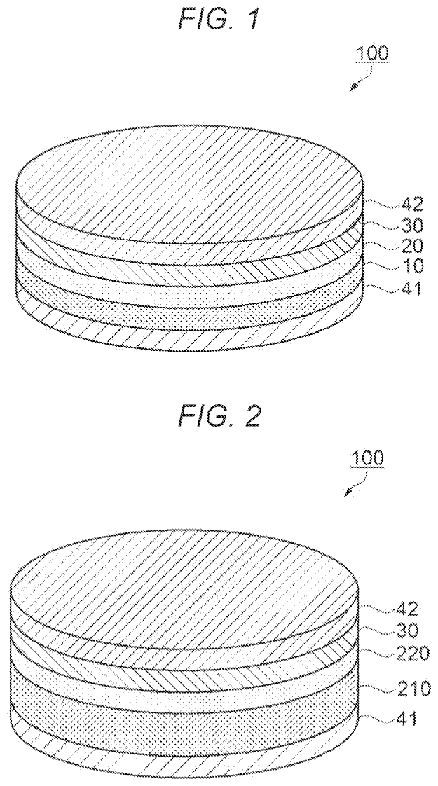

FIG. 1 is a schematic perspective view schematically showing a configuration of the lithium ion secondary battery according to the first embodiment.

As shown in FIG. 1, a lithium ion secondary battery 100 includes a positive electrode 10, a solid electrolyte layer 20 and a negative electrode 30 which are sequentially stacked on the positive electrode 10. The lithium ion secondary battery 100 further includes a current collector 41 in contact with the positive electrode 10 at a surface side opposite to a surface where the positive electrode 10 faces the solid electrolyte layer 20, and a current collector 42 in contact with the negative electrode 30 at a surface side opposite to a surface where the negative electrode 30 faces the solid electrolyte layer 20. Since each of the positive electrode 10, the solid electrolyte layer 20, and the negative electrode 30 is formed into a solid phase, the lithium ion secondary battery 100 is a chargable and dischargable all-solid-state battery.

A shape of the lithium ion secondary battery 100 is not particularly limited, and may be a polygonal plate shape or the like. In the configuration shown in the figure, the lithium ion secondary battery 100 has a disc shape. A size of the lithium ion secondary battery 100 is not particularly limited. A diameter of the lithium ion secondary battery 100 is, for example, 10 mm or more and 20 mm or less, and a thickness of the lithium ion secondary battery 100 is, for example, 0.1 mm or more and 1.0 mm or less.

When the lithium ion secondary battery 100 is thus small and thin, the lithium ion secondary battery 100 can be suitably, in the form of a chargable and dischargable all-solid body, used as a power source for a mobile information terminal such as a smartphone. As will be described below, the lithium ion secondary battery 100 may be used for applications other than the power source of the mobile information terminal.

Hereinafter, configurations of the lithium ion secondary battery 100 will be described.

### 4-1-1. Positive Electrode

The positive electrode 10 may be formed of any material as long as the material is a positive electrode active material capable of repeatedly storing and releasing electrochemical lithium ions.

Specifically, the positive electrode active material constituting the positive electrode 10 may be a lithium composite oxide containing, for example, at least Li and one or more elements selected from the group consisting of V, Cr, Mn, Fe, Co, Ni, and Cu. Examples of such a composite oxide include LiCoO₂, LiNiO₂, LiMn₂O₄, Li₂Mn₂O₃, LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄. Examples of the positive electrode active material constituting the positive electrode 10 include a fluoride such as LiFeF₃, a boride complex compound such as LiBH₄ and Li₄BN₃H₁₀, an iodine complex compound such as a polyvinylpyridine-iodine complex, and a non-metal compound such as sulfur.

In view of a conductivity and an ion diffusion distance, the positive electrode 10 is preferably formed into a thin film on one surface of the solid electrolyte layer 20.

A thickness of the positive electrode 10 formed into a thin film is not particularly limited, and is preferably 0.1 pm or more and 500 μm or less, and more preferably 0.3 μm or more and 100 μm or less.

Examples of a method for forming the positive electrode 10 include a vapor deposition method such as a vacuum deposition method, a sputtering method, a CVD method, a PLD method, an ALD method, and an aerosol deposition method, and a chemical deposition method using a solution such as a sol-gel method and an MOD method. For example, fine particles of the positive electrode active material may be slurried with an appropriate binder, sequeegeeing or screen printing may be performed to form a coating film, and the coating film may be dried and calcined to be baked on the surface of the solid electrolyte layer 20.

### 4-1-2. Solid Electrolyte Layer

The solid electrolyte layer 20 may be any layer as long as the solid electrolyte layer 20 is formed of a solid electrolyte.

Specifically, as the solid electrolyte constituting the solid electrolyte layer 20, a lithium composite oxide containing, for example, at least Li and one or more elements selected from the group formed of V, Cr, Mn, Fe, Co, Ni, and Cu may be used. Examples of such a composite oxide include LiCoO₂, LiNiO₂, LiMn₂O₄, Li₂Mn₂O₃, LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄. Examples of the solid electrolyte constituting the solid electrolyte layer 20 include a fluoride such as LiFeF₃, a boride complex compound such as LiBH₄ and Li₄BN₃H₁₀, an iodine complex compound such as a polyvinylpyridine-iodine complex, and a non-metal compound such as sulfur.

Examples of the solid electrolyte constituting the solid electrolyte layer 20 may include an oxide solid electrolyte, a sulfide solid electrolyte, a nitride solid electrolyte, a halide solid electrolyte, a hydride solid electrolyte, and a dry polymer electrolyte other than those described above, and may be a quasi-solid electrolyte crystalline material or amorphous material.

Examples of an oxide of the crystalline material include: a perovskite type crystal or a perovskite-like crystal obtained by substituting a part of elements constituting Li_{0.35}La_{0.55}TiO₃ and Li_{0.2}La_{0.27}NbO₃ and crystals thereof with N, F, Al, Sr, Sc, Nb, Ta, Sb, a lanthanoid element, and the like; a garnet type crystal or a garnet-like crystal obtained by substituting a part of elements constituting Li₇La₃Zr₂O₁₂, Li₅La₃Nb₂O₁₂, Li₅BaLa₂TaO₁₂ and crystals thereof with N, F, Al, Sr, Sc, Nb, Ta, Sb, a lanthanoid element, and the like; a NASICON type crystal obtained by substituting a part of elements constituting Li_{1.3}Ti_{1.7}Al_{0.3} (PO₄)₃, Li_{1.4}Al_{0.4}Ti_{1.6}(PO₄)₃, Li_{1.4}Al_{0.4}Ti_{1.4}Ge_{0.2}(PO₄)₃ and crystals thereof with N, F, Al, Sr, Sc, Nb, Ta, Sb, a lanthanoid element, and the like; a LISICON type crystal such as Li₁₄ZnGe₄O₁₆; and other crystalline materials such as Li_{3.4}V_{0.6}Si_{0.4}O₄, Li_{3.6}V_{0.4}Ge_{0.6}O₄, and Li₂₊ₓC₁₋ₓBO₃.

Examples of a sulfide of the crystalline material include Li₁₀GeP₂S₁₂, Li_{9.6}P₃S₁₂, Li_{9.54}Si_{1.74}P_{1.44}S_{11.7}Cl_{0.3}, and Li₃PS₄.

Examples of other amorphous materials include Li₂O—TiO₂, La₂O₃—Li₂O—TiO₂, LiNbO₃, LiSO₄, Li₄SiO₄, Li₃PO₄—Li₄SiO₄, Li₄GeO₄—Li₃VO₄, Li₄SiO₄—Li₃VO₄, Li₄GeO₄—Zn₂GeO₂, Li₄SiO₄—LiMoO₄, Li₄SiO₄—Li₄ZrO₄, SiO₂—P₂O₅—Li₂O, SiO₂—P₂O₅—LiCl, Li₂O—LiCl—B₂O₃, LiAlCl₄, LiAlF₄, LiF—Al₂O₃, LiBr—Al₂O₃, Li_{2.88}PO_{3.73}N_{0.14}, Li₃N—LiCl, Li₆NBr₃, Li₂S—SiS₂, and Li₂S—SiS₂—P₂S₅.

When the solid electrolyte layer 20 is formed of a crystalline material, the crystalline material preferably has a crystal structure such as a cubic crystal having small crystal surface anisotropy in a direction of lithium ion conduction. When the solid electrolyte layer 20 is formed of an amorphous material, anisotropy of lithium ion conduction is reduced. Therefore, any one of the crystalline materials and the amorphous materials described above is preferably used as the solid electrolyte constituting the solid electrolyte layer 20.

A thickness of the solid electrolyte layer 20 is not particularly limited, and is preferably 1.1 μm or more and 1000 μm or less, and more preferably 2.5 μm or more and 100 μm or less from a viewpoint of a charge and discharge rate.

From a viewpoint of preventing a short circuit between the positive electrode 10 and the negative electrode 30 caused by a dendritic crystal of lithium deposited at a negative electrode 30 side, a value obtained by dividing a measured weight of the solid electrolyte layer 20 by a value obtained by multiplying an apparent volume of the solid electrolyte layer 20 by a theoretical density of a solid electrolyte material, that is, a sintered density, is preferably 50% or more, and more preferably 90% or more.

Examples of a method for forming the solid electrolyte layer 20 include a green sheet method, a press calcination method, and a casting calcination method. For example, a three-dimensional pattern structure such as a dimple, a trench, or a pillar may be formed on a surface of the solid electrolyte layer 20 in contact with the positive electrode 10 or the negative electrode 30 in order to improve adhesion between the solid electrolyte layer 20 and the positive electrode 10 or adhesion between the solid electrolyte layer 20 and the negative electrode 30, and to increase an output or a battery capacity of the lithium ion secondary battery 100 by increasing a specific surface area.

### 4-1-3. Negative Electrode

The negative electrode 30 may be formed of any material as long as the material is a so-called negative electrode active material that repeatedly stores and releases electrochemical lithium ions at a potential lower than that of the material selected as the positive electrode 10. The negative electrode 30 contains at least the negative electrode active material formed using the precursor solution and the precursor powder according to the present disclosure described above.

Specifically, the negative electrode active material constituting the negative electrode 30 contains at least Li₄Ti₅O₁₂, and may further contain, for example, at least one kind of lithium composite oxide such as Nb₂O₅, V₂O₅, TiO₂, In₂O₃, ZnO, SnO₂, NiO, ITO, AZO, GZO, ATO, FTO, and Li₂Ti₃O₇. In addition to Li₄Ti₅O₁₂, the negative electrode active material constituting the negative electrode 30 may further contain, for example, metals and alloys such as Li, Al, Si, Si—Mn, Si—Co, Si—Ni, Sn, Zn, Sb, Bi, In, and Au, a carbon material, and a substance in which lithium ions are inserted between layers of carbon materials, such as LiC₂₄ and LiC₆.

In view of the conductivity and the ion diffusion distance, the negative electrode 30 is preferably formed into a thin film on the other surface of the solid electrolyte layer 20.

A thickness of the negative electrode 30 formed into a thin film is not particularly limited, and is preferably 0.1 pm or more and 500 μm or less, and more preferably 0.3 μm or more and 100 μm or less.

The negative electrode 30 can be suitably formed by, for example, coating the above precursor solution according to the present disclosure by various coating methods, and then applying the above method for producing the negative electrode active material according to the present disclosure. At this time, the precursor solution according to the present disclosure may be used in a state of being mixed with the crystalline powder-like negative electrode active material such as Li₄Ti₅O₁₂.

### 4-1-4. Current Collector

The current collectors 41 and 42 are conductors provided to transfer electrons to and receive electrons from the positive electrode 10 or the negative electrode 30. The current collector is generally formed of a material having a sufficiently small electric resistance and having substantially no change in electrical conduction characteristics or mechanical structure during charge and discharge. Specifically, examples of a constituent material of the current collector 41 on the positive electrode 10 include Al, Ti, Pt, and Au. Examples of a constituent material of the current collector 42 on the negative electrode 30 suitably include Cu.

The current collectors 41 and 42 are generally provided to reduce the corresponding contact resistance with respect to the positive electrode 10 and the negative electrode 30. Examples of a shape of the current collectors 41 and 42 include a plate shape and a mesh shape.

A thickness of each of the current collectors 41 and 42 is not particularly limited, and is preferably 7 μm or more and 85 μm or less, and more preferably 10 μm or more and 60 μm or less.

In the configuration shown in the figure, the lithium ion secondary battery 100 includes a pair of current collectors 41 and 42. Alternatively, the lithium ion secondary battery 100 may include only the current collector 41 of the current collectors 41 and 42 when, for example, a plurality of lithium ion batteries 100 are stacked and electrically connected in series.

The lithium ion secondary battery 100 may be used for any application. Examples of an electronic device to which the lithium ion secondary battery 100 is applied as a power source include a personal computer, a digital camera, a mobile phone, a smartphone, a music player, a tablet terminal, a watch, a smart watch, various printers such as an inkjet printer, a television, a projector, a head-up display, wearable terminals such as wireless headphones, wireless earphones, smart glasses, and a head mounted display, a video camera, a video tape recorder, a car navigation device, a drive recorder, a pager, an electronic notebook, an electronic dictionary, an electronic translator, a calculator, an electronic game device, a toy, a word processor, a workstation, a robot, a video phone, a security television monitor, electronic binoculars, a POS terminal, a medical device, a fish finder, various measuring devices, a mobile terminal base station device, various meters and gauges for a vehicle, a railway vehicle, an aircraft, a helicopter, a ship, and the like, a flight simulator, and a network server. The lithium ion secondary battery 100 may also be applied to a moving object such as an automobile and a ship. More specifically, the lithium ion secondary battery 100 can be suitably applied as a storage battery for an electric vehicle, a plug-in hybrid vehicle, a hybrid vehicle, or a fuel cell vehicle. In addition, the lithium ion secondary battery 100 can be applied as a household power source, an industrial power source, a solar power storage battery, and the like.

### 4-2. Lithium Ion Secondary Battery According to Second Embodiment

Next, a lithium ion secondary battery according to a second embodiment will be described.

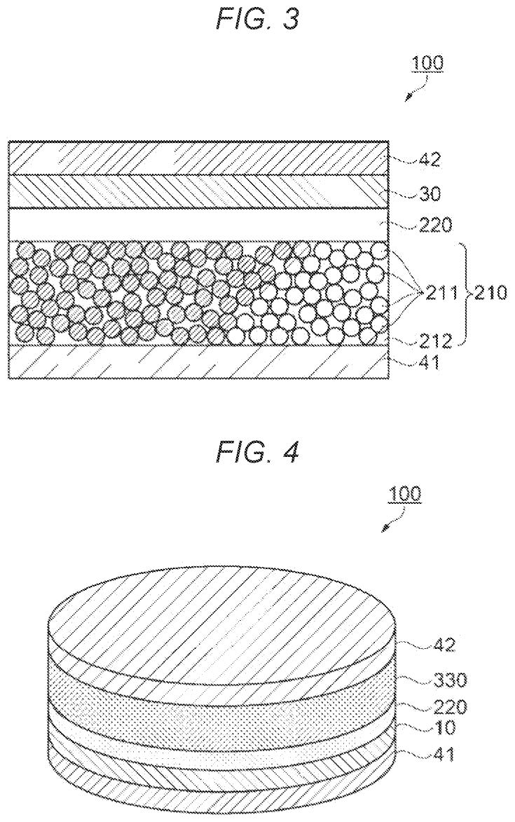

FIG. 2 is a schematic perspective view schematically showing a configuration of the lithium ion secondary battery according to the second embodiment. FIG. 3 is a schematic cross-sectional view schematically showing a structure of the lithium ion secondary battery according to the second embodiment.

Hereinafter, the lithium ion secondary battery according to the second embodiment will be described with reference to the drawings. Differences from the embodiment described above will be mainly described, and description of the same matters will be omitted.

As shown in FIG. 2, the lithium ion secondary battery 100 according to the present embodiment includes a positive electrode mixture 210 functioning as a positive electrode, and an electrolyte layer 220 and the negative electrode 30 that are sequentially stacked on the positive electrode mixture 210. The lithium ion secondary battery 100 further includes the current collector 41 in contact with the positive electrode mixture 210 at a surface side opposite to a surface where the positive electrode mixture 210 faces the electrolyte layer 220, and the current collector 42 in contact with the negative electrode 30 at a surface side opposite to a surface where the negative electrode 30 faces the electrolyte layer 220.

Hereinafter, the positive electrode mixture 210 and the electrolyte layer 220 that are different from the configuration of the lithium ion secondary battery 100 according to the embodiment described above will be described.

### 4-2-1. Positive Electrode Mixture

As shown in FIG. 3, the positive electrode mixture 210 in the lithium ion secondary battery 100 according to the present embodiment contains particulate positive electrode active materials 211 and a solid electrolyte 212. In such a positive electrode mixture 210, an area of an interface where the particulate positive electrode active materials 211 and the solid electrolyte 212 are in contact with each other is increased, so that a battery reaction rate of the lithium ion secondary battery 100 can be further increased.

An average particle diameter of the positive electrode active materials 211 is not particularly limited, and is preferably 0.1 μm or more and 150 μm or less, and more preferably 0.3 μm or more and 60 μm or less.

Accordingly, it is easy to achieve both an actual capacity density close to a theoretical capacity and high charge and discharge rates of the positive electrode active materials 211.

A particle size distribution of the positive electrode active materials 211 is not particularly limited. For example, in a particle size distribution having one peak, a half width of the peak may be 0.15 μm or more and 19 μm or less. The particle size distribution of the positive electrode active materials 211 may have two or more peaks.

Although a shape of the particulate positive electrode active materials 211 is shown as a spherical shape in FIG. 3, the shape of the positive electrode active materials 211 is not limited to the spherical shape, and may have various forms such as a columnar shape, a plate shape, a scale shape, a hollow shape, and an irregular shape. Alternatively, two or more of the various forms may be combined.

Examples of a constituent material of the positive electrode active materials 211 include materials same as the above constituent materials of the positive electrode 10 according to the first embodiment.

A coating layer may be formed on surfaces of the positive electrode active materials 211 in order to reduce an interface resistance with the solid electrolyte 212, to improve an electronic conductivity, and the like. The interface resistance of lithium ion conduction can be further reduced by forming a thin film of LiNbO₃, Al₂O₃, ZrO₂, Ta₂O₅, and the like on surfaces of particles of the positive electrode active materials 211 formed of LiCoO₂. A thickness of the coating layer is not particularly limited, and is preferably 3 nm or more and 1 μm or less.

In the present embodiment, the positive electrode mixture 210 contains the solid electrolyte 212 in addition to the positive electrode active materials 211 described above. The solid electrolyte 212 is present so as to fill spaces between the particles of the positive electrode active materials 211, or to be in contact with, particularly in close contact with, the surfaces of the positive electrode active materials 211.

Examples of the solid electrolyte 212 are the same as those described as the constituent material of the solid electrolyte layer 20 in the first embodiment.

When a content of the positive electrode active materials 211 in the positive electrode mixture 210 is XA [mass %] and a content of the solid electrolyte 212 in the positive electrode mixture 210 is XS [mass%], it is preferable to satisfy a relationship of 0.1≤XS/XA≤8.3, it is more preferable to satisfy a relationship of 0.3≤XS/XA≤2.8, and it is even more preferable to satisfy a relationship of 0.6≤XS/XA≤1.4.

In addition to the positive electrode active materials 211 and the solid electrolyte 212, the positive electrode mixture 210 may contain a conductive auxiliary and a binder.

The conductive auxiliary may be any conductive material as long as the conductive material can ignore electrochemical interaction at a positive electrode reaction potential. More specifically, examples of the conductive auxiliary include carbon materials such as acetylene black, Ketjen black, and carbon nanotubes, precious metals such as palladium and platinum, and conductive oxides such as SnO₂, ZnO, RuO₂ or ReO₃, and Ir₂O₃.

A thickness of the positive electrode mixture 210 is not particularly limited, and is preferably 1.1 μm or more and 500 μm or less, and more preferably 2.3 μm or more and 100 μm or less.

### 4-2-2. Electrolyte Layer

The electrolyte layer 220 is preferably formed of a material that is the same as or is the same type as the material of the solid electrolyte 212 from a viewpoint of an interface impedance between the electrolyte layer 220 and the positive electrode mixture 210. Alternatively, the electrolyte layer 220 may be formed of a material different from the material of the solid electrolyte 212. For example, the electrolyte layer 220 may be formed of a material having a composition different from a composition of the solid electrolyte 212.

A thickness of the electrolyte layer 220 is preferably 1.1 μm or more and 100 μm or less, and more preferably 2.5 μm or more and 10 μm or less. When the thickness of the electrolyte layer 220 is within the above range, an internal resistance of the electrolyte layer 220 can be further reduced, and occurrence of a short circuit between the positive electrode mixture 210 and the negative electrode 30 can be more effectively prevented.

For example, a three-dimensional pattern structure such as a dimple, a trench, or a pillar may be formed, for example, on a surface of the electrolyte layer 220 in contact with the negative electrode 30 in order to improve adhesion between the electrolyte layer 220 and the negative electrode 30, and to increase an output or a battery capacity of the lithium ion secondary battery 100 by increasing a specific surface area.

### 4-3. Lithium Ion Secondary Battery According to Third Embodiment

Next, a lithium ion secondary battery according to a third embodiment will be described.

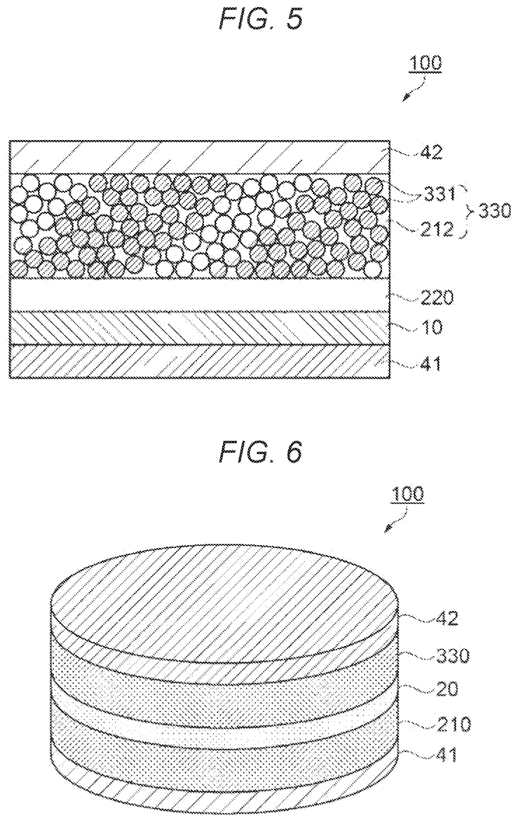

FIG. 4 is a schematic perspective view schematically showing a configuration of the lithium ion secondary battery according to the third embodiment. FIG. 5 is a schematic cross-sectional view schematically showing a structure of the lithium ion secondary battery according to the third embodiment.

Hereinafter, the lithium ion secondary battery according to the third embodiment will be described with reference to the drawings. Differences from the embodiments described above will be mainly described, and description of the same matters will be omitted.

As shown in FIG. 4, the lithium ion secondary battery 100 according to the present embodiment includes the positive electrode 10, the electrolyte layer 220 and a negative electrode mixture 330 functioning as a negative electrode that are sequentially stacked on the positive electrode 10. The lithium ion secondary battery 100 further includes the current collector 41 in contact with the positive electrode 10 at a surface side opposite to a surface where the positive electrode 10 faces the electrolyte layer 220, and the current collector 42 in contact with the negative electrode mixture 330 at a surface side opposite to a surface where the negative electrode mixture 330 faces the electrolyte layer 220.

Hereinafter, the negative electrode mixture 330 different from the configuration of the lithium ion secondary battery 100 according to the embodiments described above will be described.

### 4-3-1. Negative Electrode Mixture

As shown in FIG. 5, the negative electrode mixture 330 in the lithium ion secondary battery 100 according to the present embodiment contains negative electrode active materials 331 and the solid electrolyte 212. In such a negative electrode mixture 330, an area of an interface where the negative electrode active materials 331 and the solid electrolyte 212 are in contact with each other is increased, so that a battery reaction rate of the lithium ion secondary battery 100 can be further increased.

Examples of constituent materials of the negative electrode active materials 331 include materials same as the above constituent materials of the negative electrode 30 according to the first embodiment.

In the present embodiment, the negative electrode mixture 330 contains the solid electrolyte 212 in addition to the negative electrode active materials 331 described above. Since the negative electrode active material 331 is formed using at least the precursor solution and the precursor powder according to the present disclosure described above, the denseness of the negative electrode mixture 330 as a whole is large in the negative electrode mixture 330.

Examples of the solid electrolyte 212 are the same as those described as the constituent material of the solid electrolyte layer 20 in the first embodiment.

When a content of the negative electrode active materials 331 in the negative electrode mixture 330 is XB [mass %] and a content of the solid electrolyte 212 in the negative electrode mixture 330 is XS [mass %], it is preferable to satisfy a relationship of 0.14≤XS/XB≤26, it is more preferable to satisfy a relationship of 0.44≤XS/XB≤4.1, and it is even more preferable to satisfy a relationship of 0.89≤XS/XB≤2.1.

In addition to the negative electrode active materials 331 and the solid electrolyte 212, the negative electrode mixture 330 may contain a conductive auxiliary and a binder.

The conductive auxiliary may be any conductive material as long as the conductive material can ignore electrochemical interaction at a positive electrode reaction potential. More specifically, examples of the conductive auxiliary include carbon materials such as acetylene black, Ketjen black, and carbon nanotubes, precious metals such as palladium and platinum, and conductive oxides such as SnO₂, ZnO, RuO₂ or ReO₃, and Ir₂O₃.

A thickness of the negative electrode mixture 330 is not particularly limited, and is preferably 1.1 μm or more and 500 μm or less, and more preferably 2.3 μm or more and 100 μm or less.

### 4-4. Lithium Ion Secondary Battery According to Fourth Embodiment

Next, a lithium ion secondary battery according to a fourth embodiment will be described.

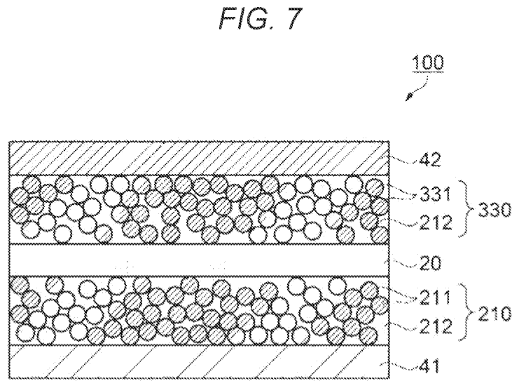

FIG. 6 is a schematic perspective view schematically showing a configuration of the lithium ion secondary battery according to the fourth embodiment. FIG. 7 is a schematic cross-sectional view schematically showing a structure of the lithium ion secondary battery according to the fourth embodiment.

Hereinafter, the lithium ion secondary battery according to the fourth embodiment will be described with reference to these drawings.

As shown in FIG. 6, the lithium ion secondary battery 100 according to the present embodiment includes the positive electrode mixture 210, and the solid electrolyte layer 20 and the negative electrode mixture 330 that are sequentially stacked on the positive electrode mixture 210. The lithium ion secondary battery 100 further includes the current collector 41 in contact with the positive electrode mixture 210 at a surface side opposite to a surface where the positive electrode mixture 210 faces the solid electrolyte layer 20, and the current collector 42 in contact with the negative electrode mixture 330 at a surface side opposite to a surface where the negative electrode mixture 330 faces the solid electrolyte layer 20.

These portions preferably satisfy the same condition as those described for corresponding portions in the embodiments described above.

In the first to fourth embodiments, another layer may be provided between layers constituting the lithium ion secondary battery 100 or on surfaces of the layers. Examples of such a layer include an adhesive layer, an insulation layer, and a protective layer.

Although the preferred embodiments according to the present disclosure have been described above, the present disclosure is not limited thereto.

For example, the precursor powder of the negative electrode active material according to the present disclosure may be formed of an inorganic substance containing lithium and titanium and have an average particle diameter of 400 nm or less. Alternatively, the precursor solution may be obtained by subjecting the precursor solution of the negative electrode active material according to the present disclosure to the heat treatment. For example, as long as the precursor powder of the negative electrode active material according to the present disclosure is formed of the inorganic substance containing lithium and titanium and has an average particle diameter of 400 nm or less, the precursor powder of the negative electrode active material according to the present disclosure may not be obtained by subjecting the precursor solution of the negative electrode active material according to the present disclosure to the heat treatment. In addition, the average particle diameter of the precursor powder of the negative electrode active material according to the present disclosure may not be 400 nm or less as long as the precursor powder is obtained by subjecting the precursor solution of the negative electrode active material according to the present disclosure to the heat treatment.

When the present disclosure is applied to a lithium ion secondary battery, a configuration of the lithium ion secondary battery is not limited to those in the embodiments described above.

For example, when the present disclosure is applied to a lithium ion secondary battery, the lithium ion secondary battery is not limited to an all-solid-state battery, and may be, for example, a lithium ion secondary battery in which a porous separator is provided between a positive electrode mixture and a negative electrode and the separator is impregnated in an electrolytic solution.

The method for producing the negative electrode active material according to the present disclosure may include steps other than the above steps. The method for producing the negative electrode active material according to the present disclosure may not include the above organic substance removal step.

### EXAMPLES

Next, specific examples according to the present disclosure will be described.

### 5. Production of Precursor Solution of Negative Electrode Active Material

First, a precursor solution was produced as follows.

### Example 1

First, 4.000 g of an ethylene glycol monobutyl ether solution of lithium nitrate as a lithium compound having a concentration of 1 mol/kg and 2 ml of ethylene glycol monobutyl ether as an organic solvent were weighed into a reagent bottle made of Pyrex (“Pyrex” is a registered trademark), and a magnet-type stirrer was put into the bottle, and the bottle was placed on a hot plate with a magnetic stirrer function.

Next, the hot plate was heated and stirred at a set temperature of 160° C. and a rotation speed of 500 rpm for 30 minutes.

Next, 2 ml of ethylene glycol monobutyl ether was added, and heating and stirring were performed again for 30 minutes.

Thereafter, 2 ml of ethylene glycol monobutyl ether was added, and heating and stirring were performed again for 30 minutes.

When the heating and stirring for 30 minutes is regarded as one dehydration treatment, a dehydration treatment is performed three times in total.

After the dehydration treatment as described above, the reagent bottle was sealed with a lid, and the hot plate was stirred at a set temperature of 25° C., i.e., a room temperature, and a rotation speed of 500 rpm, and gradually cooled to the room temperature.

Next, the reagent bottle was transferred to a dry atmosphere, and 5.000 g of an ethylene glycol monobutyl ether solution of poly(dibutyl titanate) as a titanium compound having a concentration of 1 mol/kg was weighed into the reagent bottle, and a magnet-type stirrer was put into the bottle.

Next, stirring was performed at the room temperature for 30 minutes at a rotation speed of a magnetic stirrer of 500 rpm to obtain a precursor solution.

### Examples 2 to 14

Precursor solutions were produced in the same manner as in Example 1 except that the conditions shown in Table 1 were obtained by adjusting the types and amounts of the organic solvent, the lithium compound, and the titanium compound.

The constitution of the precursor solution of each of Examples was summarized in Table 1. In Table 1, when a ratio of the titanium content and the lithium content when satisfying the stoichiometric composition of the above composition formula (1) was set as a reference, a ratio of the lithium content to the reference was shown as “ratio to reference content”. Each of the precursor solutions of Examples had a water content of 100 ppm or less. In the precursor solution of each of Examples, the lithium compound and the titanium compound were completely dissolved, and no insoluble matter was observed.

TABLE 1

| | Lithium compound | | | | Titanium compound | | Organic solvent | |
|---|---|---|---|---|---|---|---|---|
| | | Content | Ratio to reference | | | Content | | Content |
| | Compound name | [mass %] | content | | Compound name | [mass %] | Compound name | [mass %] |
| Example 1 | Lithium nitrate | 3.1 | 1.00 | time | Poly(dibutyl titanate) | 11.7 | Ethylene glycol monobutyl ether | 85.2 |
| Example 2 | Lithium nitrate | 3.2 | 1.10 | times | Poly(dibutyl titanate) | 11.2 | Ethylene glycol monobutyl ether | 85.6 |
| Example 3 | Lithium nitrate | 3.4 | 1.20 | times | Poly(dibutyl titanate) | 10.7 | Ethylene glycol monobutyl ether | 85.9 |
| Example 4 | Lithium nitrate | 3.1 | 1.00 | time | Titanium (IV) isopropoxide | 15.8 | Ethylene glycol monobutyl ether | 81.1 |
| Example 5 | Lithium nitrate | 3.2 | 1.10 | times | Titanium (IV) isopropoxide | 15.1 | Ethylene glycol monobutyl ether | 81.7 |
| Example 6 | Lithium nitrate | 3.4 | 1.20 | times | Titanium (IV) isopropoxide | 14.5 | Ethylene glycol monobutyl ether | 82.1 |
| Example 7 | Lithium nitrate | 2.9 | 0.93 | time | Poly(dibutyl titanate) | 12.0 | Ethylene glycol monobutyl ether | 85.1 |
| Example 8 | Lithium nitrate | 3.4 | 1.22 | times | Poly(dibutyl titanate) | 10.6 | Ethylene glycol monobutyl ether | 86.0 |
| Example 9 | Lithium nitrate | 2.9 | 0.92 | time | Titanium (IV) isopropoxide | 16.4 | Ethylene glycol monobutyl ether | 80.7 |
| Example 10 | Lithium nitrate | 3.4 | 1.23 | times | Titanium (IV) isopropoxide | 14.3 | Ethylene glycol monobutyl ether | 82.3 |
| Example 11 | Lithium nitrate | 3.1 | 1.00 | time | Poly(dibutyl titanate) | 11.7 | Ethyl alcohol | 85.2 |
| Example 12 | Lithium nitrate | 3.2 | 1.10 | times | Poly(dibutyl titanate) | 11.2 | Propionic acid | 85.2 |
| Example 13 | Lithium nitrate | 3.2 | 1.10 | times | Titanium (IV) isopropoxide | 15.1 | Ethyl alcohol | 81.7 |
| Example 14 | Lithium nitrate | 3.1 | 1.00 | time | Titanium (IV) isopropoxide | 15.8 | Propionic acid | 81.1 |

### 6. Production of Material Precursor Powder of Negative Electrode Active and Negative Electrode Active Material

A precursor powder and a negative electrode active material were produced by using the precursor solution of each of Examples described above in the following manner.

First, the precursor solution was put into a titanium petri dish having an inner diameter of 50 mm and a height of 20 mm, and the petri dish was placed on a hot plate. The hot plate was heated at a set temperature of 160° C. for 1 hour, and then heated at 180° C. for 30 minutes to perform an organic solvent removal step of removing the solvent.

Subsequently, an organic substance removal step of heating the hot plate at a set temperature of 360° C. for 30 minutes to decompose most of the contained organic components by burning, and further heating the hot plate at a set temperature of 540° C. for 1 hour to burn and decompose the remaining organic components was performed. Thereafter, the hot plate was gradually cooled to the room temperature, to obtain a calcined body.

Next, the calcined body was transferred to an agate mortar and subjected to a pulverization step of sufficiently pulverizing the calcined body to obtain the precursor powder of the negative electrode active material.

A part of the precursor powder was taken out, dispersed in water, and measured with a particle diameter distribution analysis device MicroTrack MT3300EXII manufactured by Nikkiso Co., Ltd., to determine the median diameter D50.

A molding step was performed in which 0.150 g of the remaining precursor powder was weighed, put into a pellet die with an exhaust port having an inner diameter of 10 mm as a molding die, and pressurized at a pressure of 624 MPa for 5 minutes to prepare temporarily a calcined body pellet as a disc-shaped molded product.

Further, the calcined body pellet was put into a crucible made of magnesium oxide with a lid made of magnesium oxide, and a calcination step of performing main calcination in an electric muffle furnace FP311 manufactured by Yamato Scientific co., ltd. was performed. The main calcination condition was 700° C. for 8 hours. Next, the electric muffle furnace was gradually cooled to the room temperature, and pellets of the negative electrode active material having a diameter of about 9.8 mm and a thickness of about 850 μm were taken out from the crucible.

A negative electrode active material according to Comparative Example 1 was produced as follows.

First, a Li₂CO₃ powder and a H₃BO₃ powder were mixed such that a molar ratio of Li to B was 3:1, and the mixture was heated at 800° C. for 1 hour to synthesize Li₃BO₃. The obtained Li₃BO₃ was pulverized using an agate bowl to obtain a Li₃BO₃ powder having D50 of 6 μm. The obtained Li₃BO₃ powder and an anatase-type TiO₂ powder having D50 of 6 μm were put into a mortar at a mass ratio of 1:2.5 and mixed to obtain a negative electrode active material powder.

Next, 0.150 g of the negative electrode active material powder was weighed, put into a pellet die with an exhaust port having an inner diameter of 10 mm as a molding die, and pressurized at a pressure of 624 MPa for 5 minutes to obtain pellets as a disc-shaped molded product. The pellets were put into a crucible made of magnesium oxide with a lid made of magnesium oxide, and subjected to a calcination treatment in an electric muffle furnace FP311 manufactured by Yamato Scientific co., ltd. The calcination treatment condition was 700° C. for 8 hours. Next, the electric muffle furnace was gradually cooled to the room temperature, and pellets of the negative electrode active material having a diameter of about 9.8 mm and a thickness of about 850 μm were taken out from the crucible.

A negative electrode active material according to Comparative Example 2 was produced as follows.

First, a Li₂CO₃ powder and a H₃BO₃ powder were mixed such that a molar ratio of Li to B was 3:1, and the mixture was heated at 800° C. for 1 hour to synthesize Li₃BO₃. The obtained Li₃BO₃ was pulverized using an agate bowl to obtain a Li₃BO₃ powder having D50 of 6 μm. The obtained Li₃BO₃ powder and an anatase-type TiO₂ powder having D50 of 6 μm were put into a mortar at a mass ratio of 1:1 and mixed to obtain a negative electrode active material powder.

Next, 0.150 g of the negative electrode active material powder was weighed, put into a pellet die with an exhaust port having an inner diameter of 10 mm as a molding die, and pressurized at a pressure of 624 MPa for 5 minutes to obtain pellets as a disc-shaped molded product. The pellets were put into a crucible made of magnesium oxide with a lid made of magnesium oxide, and subjected to a calcination treatment in an electric muffle furnace FP311 manufactured by Yamato Scientific co., ltd. The calcination treatment condition was 700° C. for 8 hours. Next, the electric muffle furnace was gradually cooled to the room temperature, and pellets of the negative electrode active material having a diameter of about 9.8 mm and a thickness of about 850 μm were taken out from the crucible.

In Comparative Example 2 in which Li₃BO₃ and TiO₂ were mixed and sintered, only LiBO₂ and a hydrate thereof LiB₂.2H₂O were confirmed as a boron compound. LiBO₂ is a substance known as a solid electrolyte having a lithium ion conductivity of about 10⁻⁹ S/cm. Li₄Ti₅O₁₂, anatase-type TiO₂, rutile-type TiO₂, and Li₂TiO₃ could be confirmed as titanium compounds, and other compounds could not be confirmed. In order to compare production amounts of the four titanium compounds, when a peak intensity of 4.83 Å (2θ:18°), i. e., a main peak of Li₄Ti₅O₁₂, was taken as 100, intensity ratios of 3.51 Å (2θ:25°), 3.25 Å (2θ:27°), and 2.07 Å (2θ:43°), i. e., main peaks of anatase-type TiO₂, rutile-type TiO₂, and Li₂TiO₃, were calculated based on an X-ray diffraction pattern. As a result, only the main peak of Li₂TiO₃ was strongly detected.

### 7. Evaluation

The pellets of the negative electrode active material according to each of Examples and Comparative Examples obtained as described above were evaluated as follows.

### 7-1. Evaluation of Denseness

With respect to the pellets of the negative electrode active materials according to Examples and Comparative Examples, the diameter was measured using a Digimatic caliper CD-15APX manufactured by Mitutoyo Corporation, and the thickness was measured using a Mumate, a digital micrometer manufactured by Sony Corporation. A bulk density was obtained based on the volume of the pellet of the negative electrode active material and a mass of the pellet of the negative electrode active material obtained from the above measurement values, and the denseness of the pellet of the negative electrode active material was obtained as a ratio of the bulk density to the specific gravity 3.418 of Li₄Ti₅O₁₂. It can also be said that the larger the bulk density, the smaller the number of voids and the better the denseness.

### 7-2. Evaluation of Total Lithium Ion Conductivity

Two sides of the pellets of the negative electrode active material according to each of Examples and Comparative Examples were attached with a lithium metal foil (manufactured by Honjo Chemical Corporation) having a diameter of 5 mm to form activation electrodes, and an alternating current impedance was measured using an alternating current impedance analyzer Solatron 1260 (manufactured by Solatron Analytical Corporation) to obtain a lithium ion conductivity. The measurement was performed at an alternating current amplitude of 10 mV in a frequency range of 10⁷ Hz to 10⁻¹ Hz. The lithium ion conductivity obtained by the measurement shows a total lithium ion conductivity including a bulk lithium ion conductivity of the pellet of each negative electrode active material and a lithium ion conductivity at a grain boundary. The larger the value of the lithium ion conductivity, the better the ion conductivity.

These results are summarized in Table 2 together with the median diameter D50 of the precursor powder, a crystal structure of the negative electrode active material obtained by XRD measurement, and presence or absence of impurities in the negative electrode active material. The crystal structure of the negative electrode active material was determined based on an X-ray diffraction pattern obtained by measurement using an X-ray diffraction device X'Pert-PRO manufactured by Philips Corporation, using pellets of the negative electrode active material of each of Examples and Comparative Examples as a sample. The content of the organic substance contained in each of the precursor powders according to Examples was 100 ppm or less.

TABLE 2

| | Median | Crystal structure of | Presence or | | |
|---|---|---|---|---|---|
| | diameter | negative electrode | absence of | Denseness | Total lithium ion |
| | D50 [nm] | active material | impurities | [%] | conductivity |
| Example 1 | 300 | Spinel | Absence | 94 | 2.0 × 10⁻⁹ |
| Example 2 | 310 | Spinel | Absence | 92 | 7.3 × 10⁻⁹ |
| Example 3 | 305 | Spinel | Absence | 90 | 1.8 × 10⁻⁹ |
| Example 4 | 295 | Spinel | Absence | 95 | 2.3 × 10⁻⁹ |
| Example 5 | 303 | Spinel | Absence | 93 | 2.1 × 10⁻⁹ |
| Example 6 | 306 | Spinel | Absence | 90 | 2.2 × 10⁻⁹ |
| Example 7 | 301 | Spinel | Presence | 70 | 9.3 × 10⁻¹⁰ |
| | | | (TiO₂, Li₂TiO₃) | | |
| Example 8 | 304 | Spinel | Presence | 69 | 9.0 × 10⁻¹⁰ |
| | | | (TiO₂, Li₂TiO₃, LiTi₂O₄) | | |
| Example 9 | 296 | Spinel | Presence | 71 | 9.5 × 10⁻¹⁰ |
| | | | (TiO₂, Li₂TiO₃) | | |
| Example 10 | 308 | spinel | Presence | 68 | 8.5 × 10⁻¹⁰ |
| | | | (TiO₂, Li₂TiO₃, LiTi₂O₄) | | |
| Example 11 | 302 | Spinel | Absence | 93 | 2.1 × 10⁻⁹ |
| Example 12 | 311 | Spinel | Absence | 92 | 7.4 × 10⁻⁹ |
| Example 13 | 304 | Spinel | Absence | 94 | 2.2 × 10⁻⁹ |
| Example 14 | 296 | Spinel | Absence | 96 | 2.2 × 10⁻⁹ |
| Comparative | 6000 | Spinel | Absence | 52 | 5.0 × 10⁻¹⁰ |
| Example 1 | | | | | |
| Comparative | 6010 | Spinel | Presence | 50 | 3.0 × 10⁻¹⁰ |
| Example 2 | | | (TiO₂, Li₂TiO₃) | | |

As is clear from Table 2, excellent results were obtained in each of Examples. In contrast, satisfactory results were not obtained in each of Comparative Examples.

When the production of the pellets of the negative electrode active material was attempted in the same manner as described above except that the heating temperature in the organic solvent removal step was variously changed in a range of 131° C. or higher and 211° C. or lower using the precursor solution of each of Examples, the pellets of the negative electrode active material could be suitably produced in all cases. When the production of the pellets of the negative electrode active material was attempted in the same manner as described above except that the treatment time in the organic solvent removal step was variously changed in a range of 20 minutes or longer and 240 minutes or shorter, the pellets of the negative electrode active material could be suitably produced in all cases. When the production of the pellets of the negative electrode active material was attempted in the same manner as described above except that the heating temperature in the organic substance removal step was variously changed in a range of 280° C. or higher and 650° C. or lower, the pellets of the negative electrode active material could be suitably produced in all cases. When the production of the pellets of the negative electrode active material was attempted in the same manner as described above except that the treatment time in the organic substance removal step was variously changed in a range of 20 minutes or longer and 240 minutes or shorter, the pellets of the negative electrode active material could be suitably produced in all cases. When the production of the pellets of the negative electrode active material was attempted in the same manner as described above except that the load during the press molding was variously changed in a range of 300 MPa or more and 1000 MPa or less, the pellets of the negative electrode active material could be suitably produced in all cases. When the production of the pellets of the negative electrode active material was attempted in the same manner as described above except that the heating temperature in the calcination step was variously changed in a range of 700° C. or higher and 1200° C. or lower, the pellets of the negative electrode active material could be suitably produced in all cases. When the production of the pellets of the negative electrode active material was attempted in the same manner as described above except that the treatment time in the calcination step was variously changed in a range of 1 hour or longer and 24 hours or shorter, the pellets of the negative electrode active material could be suitably produced in all cases. When the pellets of the negative electrode active materials were evaluated in the same manner as described above, excellent results were obtained in all cases in the same manner as described above.

What is claimed is:

1. A precursor solution of a negative electrode active material comprising:
at least one kind of organic solvent;
a lithium compound that exhibits solubility in the organic solvent; and
a titanium compound that exhibits solubility in the organic solvent.

2. The precursor solution of a negative electrode active material according to claim 1, wherein
when a ratio of a titanium content and a lithium content when satisfying a stoichiometric composition of a composition formula (1) below is set as a reference, the titanium compound and the lithium compound are contained such that the lithium content is 1.00 time or more and 1.20 times or less with respect to the reference.
Li₄Ti₅O₁₂ (1)

3. The precursor solution of a negative electrode active material according to claim 1, wherein
the lithium compound is a lithium metal salt compound, and
the titanium compound is a titanium alkoxide.

4. The precursor solution of a negative electrode active material according to claim 3, wherein
the lithium metal salt compound is an oxoacid salt.

5. The precursor solution of a negative electrode active material according to claim 4, wherein
the lithium metal salt compound is a nitrate.

6. The precursor solution of a negative electrode active material according to claim 3, wherein
a water content in the precursor solution of a negative electrode active material is 300 ppm or less.

7. The precursor solution of a negative electrode active material according to claim 1, wherein
the organic solvent is a non-aqueous solvent containing one or more selected from the group consisting of n-butyl alcohol, ethylene glycol monobutyl ether, butylene glycol, hexylene glycol, pentanediol, hexanediol, heptanediol, toluene, orthoxylene, paraxylene, hexane, heptane, and octane.

8. A precursor powder of a negative electrode active material comprising:
an inorganic substance containing lithium and titanium, wherein
an average particle diameter is 400 nm or less.

9. The precursor powder of a negative electrode active material according to claim 8, further comprising:
an oxoacid compound.

10. A precursor powder of a negative electrode active material, which is obtained by subjecting the precursor solution of a negative electrode active material according to claim 1 to a heat treatment.

11. A method for producing a negative electrode active material comprising:
an organic solvent removal step of removing an organic solvent by heating the precursor solution of a negative electrode active material according to claim 1;
a molding step of molding a precursor powder of the negative electrode active material obtained in the organic solvent removal step to obtain a molded body; and
a calcination step of calcinating the molded body.

12. The method for producing a negative electrode active material according to claim 11, further comprising:
between the organic solvent removal step and the molding step, an organic substance removal step of removing an organic substance contained in a composition obtained by removing the organic solvent from the precursor solution of a negative electrode active material.

13. The method for producing a negative electrode active material according to claim 11, wherein
a denseness of the negative electrode active material is 60% or more.
